(19) United States
(12) Patent Application Publication
(10) Pub. No.: US 2013/0075295 A1
(43) Pub. Date: Mar. 28, 2013

(54) DISPOSABLE CONTAINER AND LID MATCHING SYSTEM AND METHODS

(71) Applicant: CHRISTOPHER L. SINA, Neenah, WI (US)

(72) Inventor: CHRISTOPHER L. SINA, Neenah, WI (US)

(21) Appl. No.: 13/240,437

(22) Filed: Sep. 22, 2011

(51) Int. Cl. B65D 85/00; B23P 19/04

(52) U.S. Cl. 206/459.5; 29/428

(57) ABSTRACT

A disposable container and lid arrangement includes a container with at least one graphic arbitrary symbol thereon. A lid that is sized to releasably fit on the container will have a matching graphic arbitrary symbol. A method of putting a lid on a disposable container includes viewing the container to see at least one of first and second graphic symbols, locating a lid that will fit the container by looking for a lid having a symbol that matches the first and second symbols, and then placing the selected lid on the container.

### TECHNICAL FIELD

This disclosure concerns disposable containers and lids. In particular, this disclosure concerns systems and methods to allow a person to quickly and conveniently locate a properly sized lid for a particular container.

### BACKGROUND

Disposable storage containers are well known in the art. These containers generally include a lid that is selectively detachable from a container or bowl and are commonly designed to provide a variety of features, including being reusable, disposable, microwaveable, and the like.

These containers come in a variety of sizes. The containers can be rectangular shape, including square, or they may be round in shape. Frequently, the containers and lids become separated by the consumer when they are stored for later use. When it becomes time to find the properly sized lid that fits onto the container, it can be challenging due to the multiple sizes and shapes of the containers and lids. Improvements are desirable.

### SUMMARY

A disposable container and lid arrangement is provided. The container will have at least a first graphic arbitrary symbol, and the lid that is sized to releasably fit on the container will have the same graphic arbitrary symbol. In this manner, by matching the symbols, a consumer will be able to select a properly fitting lid from a variety of lids. Or, the consumer with the selected lid will be able to select the properly sized container from a variety of containers by matching the graphic arbitrary symbol on the lid and container.

In one aspect, a container has a bottom and a surrounding wall extending from the bottom. The bottom and the wall define a container volume. The wall has an end remote from the base and defines a lid-receiving rim. The wall has at least first and second opposing wall sections. A first graphic arbitrary symbol is on the first wall section, and a second graphic arbitrary symbol is on the second wall section. The second graphic symbol is the same as the first graphic symbol. A lid is sized to releasably fit on the rim and provide a cover to the container volume. A third graphic arbitrary symbol is on the lid. The third graphic symbol is the same as the first and second graphic symbols.

In one embodiment, the surrounding wall forms a circular shape. In another embodiment, the surrounding wall forms a rectangular shape. The rectangular shape can be a square shape.

In one preferred arrangement, the container has a central vertical axis, and the first and second graphic symbols overlap with each other as the container is rotated 180 degrees about the central vertical axis.

Preferably, the first, second, and third graphic symbols are non-numeric and non-alphabetic. Example embodiments of graphic symbols include a heart, a moon (e.g., a crescent moon), a star, a plus sign, and a clover shape.

In another aspect, a method of putting a lid on a disposable container includes providing a container having at least a first graphic arbitrary symbol; and locating a lid sized to fit the container by looking for a lid having a graphic arbitrary symbol that is the same as the graphic arbitrary symbol on the container.

In one aspect, the method of putting a lid on a disposable container includes providing a container having a bottom and a surrounding wall extending from the bottom. The bottom and the wall define a container volume. The wall has an end remote from the base, and the end defines a lid-receiving rim. The wall has at least first and section opposing wall sections. A first graphic arbitrary symbol is on the first wall section, and a second graphic arbitrary symbol is on the second wall section. The second graphic symbol is the same as the first graphic symbol. The method also includes the step of viewing the container to see at least one of the first and second graphic symbols. Next, there is a step of locating a lid sized to fit the rim of the container by looking for a lid having a third graphic arbitrary symbol on it. The third graphic symbol will be the same as the first and second graphic symbols. Next, there is the step of operably placing the lid on the rim of the container to cover the container volume.

It is noted that not all the specific features described herein need to be incorporated in an arrangement for the arrangement to have some selected advantage according to the present disclosure.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate example embodiments of the invention and together with the description, serve to explain the principles of the invention.

FIG. 1 is a perspective view of a first embodiment of a disposable container and lid arrangement, constructed in accordance with principles of this disclosure;

FIG. 2 is a front view of the container of FIG. 1;

FIG. 3 is a rear view of the container of FIG. 1;

FIG. 4 is a perspective view of another embodiment of a container, constructed in accordance with principles of this disclosure;

FIG. 5 is a perspective view of another embodiment of a lid for the container of FIG. 4, constructed in accordance with principles of this disclosure;

FIG. 6 is a perspective view of another embodiment of a lid, constructed in accordance with principles of this disclosure;

FIG. 7 is a perspective view of another embodiment of a lid, constructed in accordance with principles of this disclosure; and

FIG. 8 is a perspective view of another embodiment of a lid, constructed in accordance with principles of this disclosure.

### DETAILED DESCRIPTION

A disposable container and lid arrangement includes a system to allow for convenient and quick matching of a properly sized lid with the container. The system includes looking at a graphic symbol on the container and then looking for a lid having that same graphic symbol. The lid having that same graphic symbol will be a lid that properly fits on the container. The graphic symbol will be an arbitrary symbol. By the term “graphic arbitrary symbol,” it is meant that, other than as a matching system, the symbol is not provided to impart any information; that is, the symbol does not advise on the type of plastic (it is plastic-uninformative); it does not provide information on recycling (it is recycling-uninformative); it does not provide volume size or measurement information (it is size-uninformative and measurement-uninformative); it does not form a date code (it is date-uninformative); it does not provide information about the contents of the container (is it content-uninformative), etc. In addition, while it is theoretically possible that the symbol forms a word, the word is not an informative word—rather, if forming a word, it would arbitrary and have no informative purpose other than as use in the matching system. The arbitrary graphic symbol is a symbol that has no purpose other than to be part of the match system. As such, the arbitrary graphic symbol is limited to being match-only and otherwise uninformative.

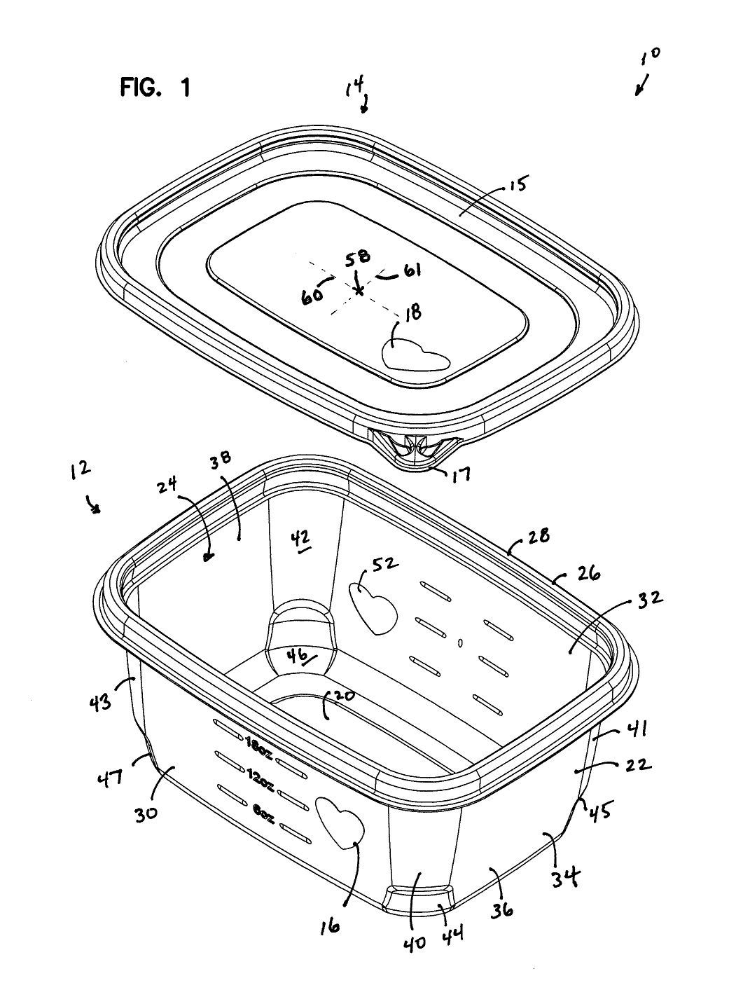

In reference to FIG. 1, a first embodiment of a disposable container and lid arrangement is shown generally at 10. The container and lid arrangement 10 includes a container 12 and a lid 14 that fits the container 12. In general, the container 12 will have at least a first graphic arbitrary symbol 16 located thereon. The lid 14 will have the same graphic arbitrary symbol 18 thereon. By the term “the same,” it is meant that the shape of the symbols 16, 18 are identical, or substantially or nearly so, even though the size or orientation may be different—that is, in the mind's eye, a person will generally perceive the symbols to be the same, even though a different size or a mirror image may be used (for example, a left and right human hand image may be used, which are mirror images of each other). In the example shown in FIG. 1, the symbols 16, 18 are heart-shaped. Still in reference to FIG. 1, the container 12 has a bottom 20 and a surrounding wall 22 extending from the bottom 20. The bottom 20 and the surrounding wall 22 define a container volume 24. The volume 24 can be used to hold whatever is being stored in the container, including food or non-food items (such as detergent, hardware, toys, coins, office supplies, etc.).

The surrounding wall 22 defines an end 26 remote from the bottom 20. The end 26 defines a lid-receiving rim 28. The rim 28 is shaped with a profile to allow it to engage in a snap-fit and form a seal with the lid 14. This type of fit between the rim 28 of the container 12 and the lid 14 is conventional and known in the art.

The surrounding wall has at least a first wall section 30 and a second wall section 32 in opposition to each other to form opposing wall sections 30, 32. In the embodiment shown in FIG. 1, the surrounding wall 22 forms a rectangular shape 34 including the opposing first and second wall sections 30, 32 and also including opposing third and fourth wall sections 36, 38 between the first and second wall sections 30, 32. The rectangular shape 34 can include a square shape, but in this embodiment the shape is non-square, in that that first and second wall section 30, 32 are longer than the third and fourth wall sections 36, 38. By the term “rectangular shape,” it does not mean a precise exact geometric rectangle; rather, the wall sections 30, 32, 36, 38 can be rounded at the corners. In the embodiment shown in FIG. 1, the intersection between the first wall section 30 and the third wall section 36 has a rounded corner 40. Similarly, there are rounded corners 41, 42, 43 between the second wall section 32 and third wall section 36; between the second wall section 32 and the fourth wall section 38; and between the first wall section 30 and the fourth wall section 38. Further, in this particular embodiment, the rounded corners 40-43 have indented regions 44, 45, 46, 47 between the respective rounded corner 40-43 and the bottom 20.

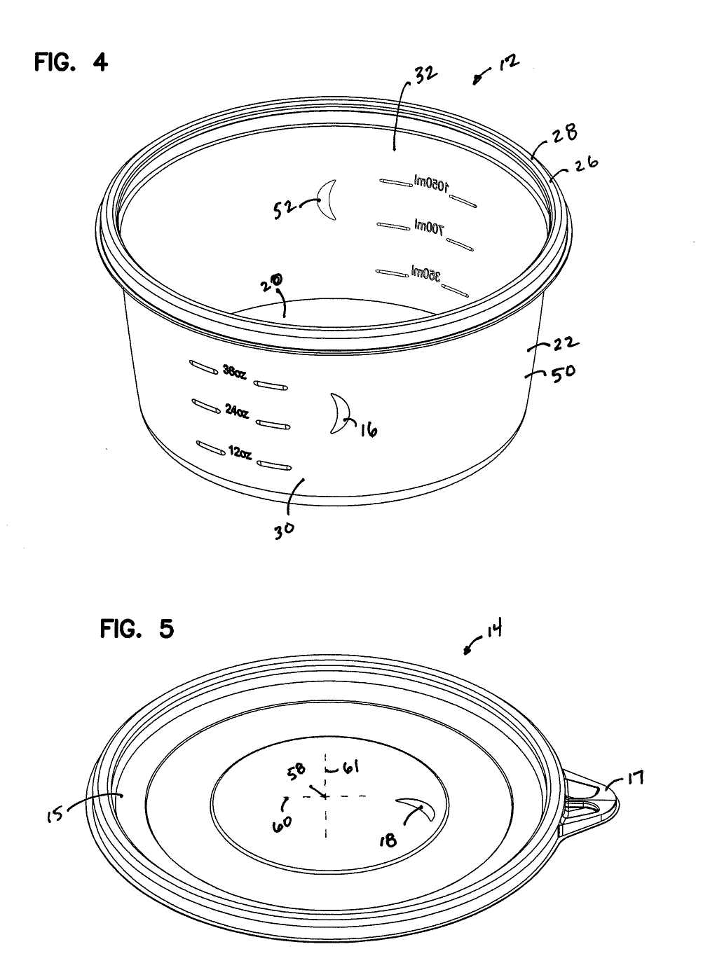

In the embodiment of FIG. 4, the surrounding wall 22 forms a circular shape 50.

The first graphic arbitrary symbol 16 is located on the first wall section 30. The symbol 16 may be a shape molded in as part of the wall 22, or it may be applied only with printing techniques. If molded as part of the wall 22, a person who is visually impaired can feel the shape of the symbols 16, 18 in order to match them, but it should be understood that the symbols 16, 18 are arbitrary and do not constitute Braille (e.g., the symbols 16, 18 are “non-Braille”).

In some non-limiting example arrangements, the container 12 will be constructed and arranged such that the graphic symbol is visible to the consumer regardless of the particular orientation of the container 12 relative to the consumer. To achieve this preferred implementation, the container 12 further includes a second arbitrary symbol 52 on the container 12. The second graphic symbol 52 will be in a location different from where the first symbol 16 is located. In the example embodiment shown, the second graphic symbol 52 is on the second wall section 32. The second graphic symbol 52 will be the same symbol as the first graphic symbol 16. Again, by the term “same,” it is meant that the symbols will have substantially the same shape and usually the same size, but not necessarily. In addition, in some embodiments, they may be mirror images of each other.

Many different ways to orient the first symbol 16 and second symbol 52 are possible. One non-limiting example way includes having the first symbol 16 be on the first wall section 30, and the second graphic symbol 52 be on the second wall section 32 such that an imaginary straight line that extends through the container volume 24 between the first symbol 16 and second symbol 52 is non-perpendicular to the first wall section 30 and the second wall section 32. In other words, the line will be slanted or diagonal. This orientation of the first symbol 16 and second symbol 52 relative to the surrounding wall 22 will make it more likely that at least one of the symbols 16, 52 will be visible to the consumer for any given orientation of the container 12.

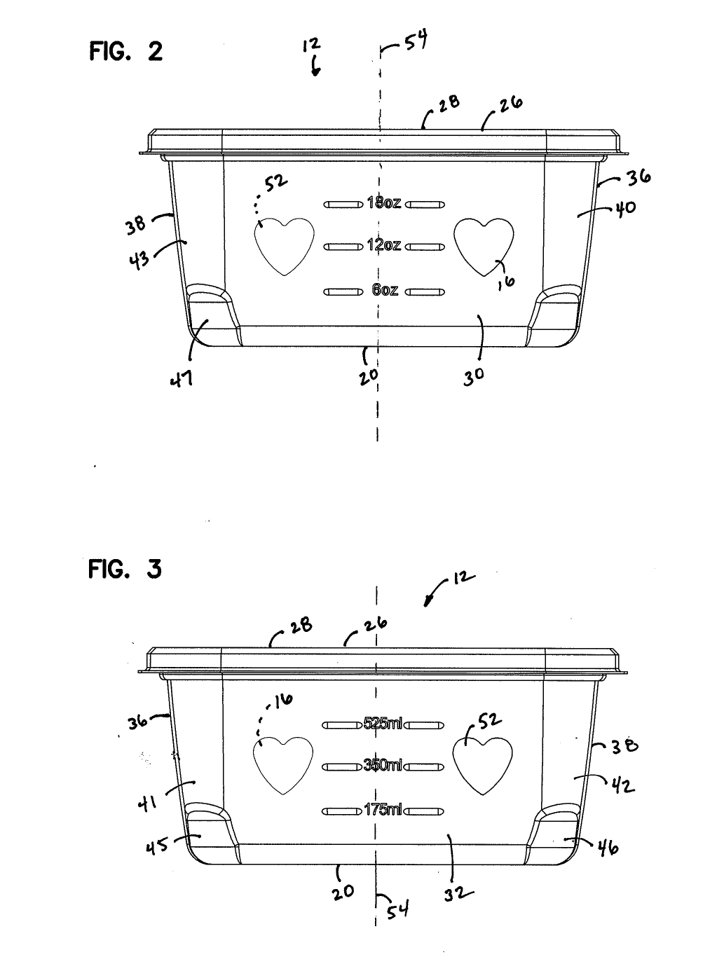

Attention is directed to FIGS. 2 and 3. In the particular non-limiting example shown in FIGS. 2 and 3, the first graphic symbol 16 is located off-center on the first wall section 30. In the example shown, the first graphic symbol 16 is located closer to the third wall section 36 than the fourth wall section 38. In the example embodiment illustrated, the second graphic symbol 52 is located off-center on the second wall section 32. In the embodiment shown, the second graphic symbol 52 is located closer to the fourth wall section 38 than the third wall section 36. The embodiments of FIGS. 2 and 3 show the container 12 made from a transparent material, which is why the symbols 16, 52 are visible from each of the front and rear views. When the container 12 is filled with an opaque material, only one of the symbols 16, 52 would be visible from the orientation of FIGS. 2 and 3.

In some non-limiting example arrangements, the container 12 defines a two-fold symmetry around a central vertical axis 54. In other words, in some example embodiments, when the container 12 is rotated about central axis 54, the first symbol 16 and the second symbol 52 will overlap with each other because they are symmetrical at 180 degrees. In other embodiments, the first symbol 16 and second symbol 52 can be within about 25% of the two-fold symmetry around the vertical axis 54. Of course, other arrangements are possible.

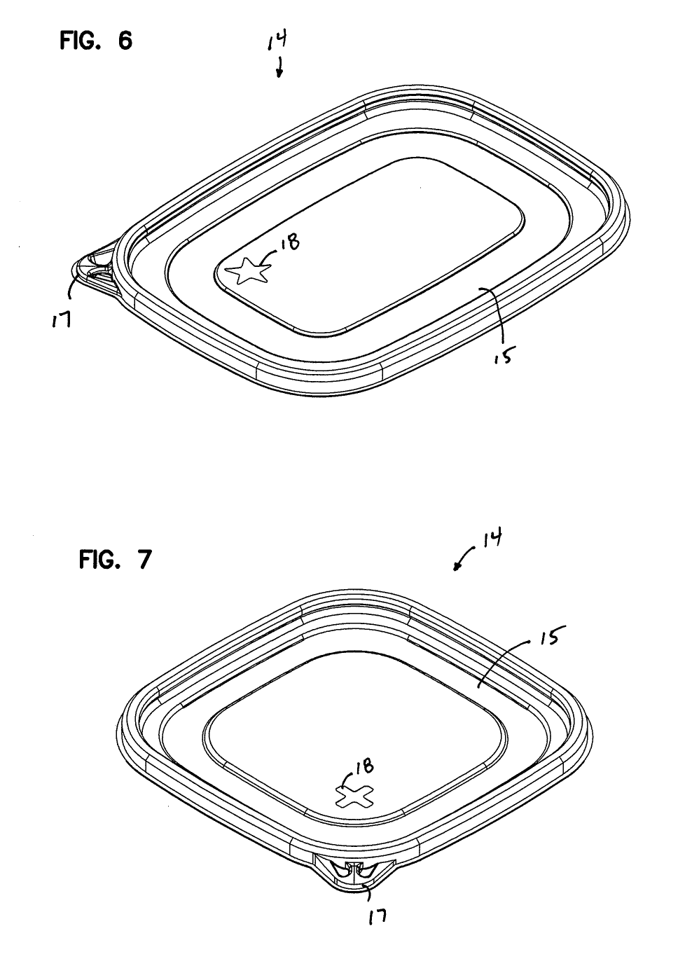

In reference again to FIG. 1, the lid 14 is sized to releasably fit on the rim 28 with a snap fit and preferably form a seal between the lid 14 and the container 12. The lid 14 then provides a cover 56 to the container volume 24. In the particular example shown in FIG. 1, the lid 14 has a body 15 and has a lift tab 17 extending from the body 15. In FIG. 1, the body 15 is rectangular shaped, while in FIG. 5, the body is round shaped. As mentioned previously, the lid 14 includes graphic arbitrary symbol 18 and, in non-limiting example embodiments, will be the third graphic arbitrary symbol with the first and second symbols 16, 52 being on the container 12. The third graphic symbol 18 will be the “same” symbol as the first and second graphic symbols 16, 52. See the definition above of “same”, which is applicable here.

The lid 14 has a center 58. The lid 14 can be viewed as having imaginary first and second intersecting perpendicular lines 60, 61 that intersect at the center 58. These lines 60, 61 divide the lid 14 into four approximately equal quadrants. Preferably, the third graphic symbol 18 is on the lid 14 off-center and located in only one of the four quadrants. Preferably, the third symbol 18 will not intersect with the center 58, although such an arrangement is possible in other embodiments. Preferably, the third symbol 18 will not extend into more than one of the quadrants, but such an arrangement is possible and contemplated for other embodiments.

In the example embodiment shown, when the lid 14 is operably oriented on the rim 28 of the container 12, the third graphic symbol 18 is at one of two possible positions: (i) closer to the first wall section 30 and third wall section 36 than the second wall section 32 and fourth wall section 38; and (ii) closer to the second wall section 32 and fourth wall section 38 than the first wall section 30 and third wall section 36. When the third symbol 18 is located on the lid 14 in this manner, then when the lid 14 is properly fit onto the proper sized container 12, the third symbol 18 will be located close or adjacent to one of the first symbol 16 or the second symbol 52 in the embodiment of FIG. 1. In the embodiment of FIGS. 4 and 5, because the container 12 is round and the lid 14 is round, the lid 14 can be located at any orientation along the rim 28, which will locate the third symbol 18 at any location relative to the first symbol 16 and second symbol 52.

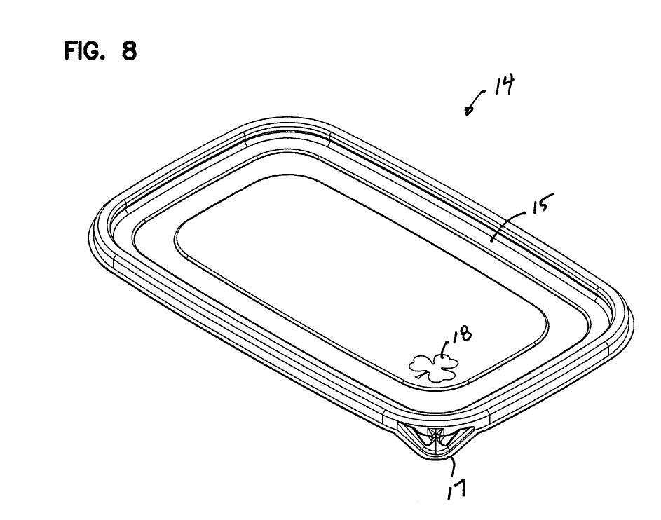

FIGS. 6, 7, and 8 show three additional embodiments of lids 14. Each of the lids 14 has a different size and/or shape than the lid of FIG. 1 and a different size and shape than the lid of FIG. 5. As can be appreciated by comparing between the lids of FIGS. 1, 5, 6, 7, and 8, each lid 14 has a different geometry and different size from the others. Each differently sized lid 14 accordingly has a different third symbol 18. In the lid 14 of FIG. 1, the symbol 18 is a heart shape. In the lid 14 of FIG. 5, the symbol 18 is a moon (e.g., crescent moon) shape. In the lid 14 of FIG. 6, the symbol 18 is a star shape. In FIG. 7, the lid 14 has symbol 18 in the shape of a plus sign. In the lid 14 of FIG. 8, the symbol 18 is a clover shape. In the examples shown, the symbol 18 is located on the body 15 of the lid 14 at the section or quadrant of the lid 14 nearest to the lift tab 17. Of course, the symbol 18 can be located elsewhere on the lid 14.

In these examples, the container 12 having the heart shape symbols 16, 52 will be a different size or shape or geometry than: (i) the container 12 having the moon shaped symbols; and (ii) the container 12 having the star shaped symbols; and (iii) the container 12 having the plus sign symbols; and (iv) the container having the clover shaped symbols. In addition, each one of these containers with the different symbols 16, 52 is different from each of the other containers. It is contemplated, however, that in some embodiments there can be containers 12 of a different volume size but that have the same sized and shaped rim 28, allowing the same sized lid 14 to fit the rim 28 of the containers 12, and in those cases, the containers 12 of different volume size will have the same symbol 16, 52.

The symbols 16, 52, 18 can be used in a method to identify a properly sized lid 14 for the given sized container 12. For example, if a first person is using a certain container 12, that first person can communicate to a second person to find the lid 14 that would fit the container by merely identifying the symbol 18 on the lid 14. For example, the first person, if using container 12 having the star symbols, would say to the second person: “Please bring me a star lid.” There would be no need for the first person to try to explain the size or geometry of the container 12 to the second person. All of the information that is needed for the second person to get the properly sized lid 14 is an identification or description of the symbol needed.

When shopping for additional containers 12, assuming the consumer wants additional containers 12 of the same size or geometry, the consumer can identify the desired container size by looking for the correct symbol. For example, if the consumer has containers 12 with clovers as the symbols 16, 52 and the consumer wants to purchase more of that same sized/shaped container 12, the consumer can just look for the container 12 having the clover shape; in addition, the consumer can communicate the information to a second person shopping for them by describing only the symbol and without having to describe size, or geometry, or brand: “Please buy two more packages of containers having the clover symbol on them.” As such, the symbols 16, 52, and 18 are a means to identify the container 12, once separated from the lid 14.

It should be understood that many different arbitrary symbols can be used. In preferred embodiments, the first, second, and third graphic symbols 16, 52, 18 are non-numeric. That is, the symbols will not be numbers in preferred embodiments. Other embodiments are possible that include numbers.

In preferred embodiments, the first, second, and third symbols 16, 52, 18 will be non-alphabetic. That is, in some examples, the symbols 16, 52, and 18 will not consist only of letters of the English alphabet. In other embodiments, numeric or alphabetic characters, or some combination including a combination with non-alphabetic and non-numeric symbols, may be used. Further, alphabetic symbols from a non-English language are contemplated. In the examples shown in the drawings, the symbols 16, 18, 52 are both non-numeric and non-alphabetic.

Preferably, the symbols 16, 18, 52 will be large enough so that a consumer with poor vision is able to easily see the symbol. Preferably, the symbols 16, 18, 52 will have a size with a height greater than 0.5 inch and a width greater than 0.5 inch. The symbols 16, 18, 52 need not be identical in size. For example, it is contemplated that the third symbol 18 on the lid 14 can be larger than the first and second symbols 16, 52. The reverse is also contemplated. In addition, the first symbol 16 and second symbol 52 can be differing in size between each other. In many typical arrangements, the first, second, and third symbols 16, 52, 18 will have a height no greater than 5 inches and a width no greater than 3 inches. Typically, the first, second, and third symbols 16, 52, 18 will have a size within 25% of each other.

In FIG. 1, while the first symbol 16 and second symbol 52 are shown on the first wall section 30 and second wall section 32, respectively, it is contemplated that the first symbol 16 could be located on the rounded corner 40, while the second symbol 52 is on the opposite rounded corner 42; or, one symbol 16 may be on a rounded corner, while another on any one of the wall sections. As mentioned above, there are many different possibilities for possible arrangements of the symbols 16, 18, 52 relative to each other.

A method of putting the lid 14 on the disposable container 12 includes viewing the container 12 to see at least one of the first and second graphic symbols 16, 52. Next, there is a step of locating the lid 14 that is sized to fit the rim 28 of the container 12 by looking for the lid 14 having third symbol 18 on it. For example, in FIG. 1, the consumer would see the heart shape on the container 12 and then look for the lid 14 that has the heart shape. The third symbol 18 would be the same as the first and second symbols 16, 52 on the container 12. After the proper lid 14 is identified by finding the matching symbol 18, the lid 14 is operably placed on the rim 28 of the container 12 to cover the container volume 24.

The step of viewing the container 12 to see at least one of the first and second symbols 16, 52 will include, in one example, seeing a non-numeric and non-alphabetic graphic in preferred embodiments. For example, it will include seeing a heart, a crescent-shaped moon, a star, a plus sign, or a clover. Other examples would include nature symbols (butterfly, flower, leaves, etc.); or fruit shapes (e.g., banana, apple, grape, strawberry); or card suits (diamond, heart, spade, and club) or body parts (hand, foot, eye, nose, mouth), or various geometric shapes.

The above represents example principles. Many embodiments can be made applying these principles. It is noted that not all the specific features described herein need to be incorporated in an arrangement for the arrangement to have some selected advantage according to the present disclosure.

1. A disposable container and lid arrangement comprising:
(a) a container having a bottom and a surrounding wall extending from the bottom;
(i) the bottom and wall defining a container volume;
(ii) the wall having an end remote from the bottom; the end defining a lid-receiving rim;
(iii) the wall having at least a first wall section and a second opposing wall section;
(A) a first graphic arbitrary symbol defined on the first wall section; the first graphic arbitrary symbol having a purpose exclusively for use in a matching system and being otherwise uninformative;
(B) a second graphic arbitrary symbol defined on the second wall section; the second graphic symbol being the same as the first graphic symbol; the second graphic arbitrary symbol having a purpose exclusively for use in a matching system and being otherwise uninformative; and
(b) a lid sized to releasably fit on the rim and provide a cover to the container volume;
(i) a third graphic arbitrary symbol defined on the lid; the third graphic symbol being the same as the first and second graphic symbols; the third graphic arbitrary symbol having a purpose exclusively for use in a matching system and being otherwise uninformative.

2. A container and lid arrangement according to claim 1 wherein:
(a) a straight line through the container volume between the first graphic symbol and second graphic symbol is non-perpendicular to the first wall section and the second wall section.

3. A container and lid arrangement according to claim 2 wherein:
(a) the surrounding wall forms a circular shape.

4. A container and lid arrangement according to claim 2 wherein:
(a) the surrounding wall forms a rectangular shape including the opposing first and second wall sections, and opposing third and fourth wall sections between the first and second wall sections.

5. A container and lid arrangement according to claim 1 wherein:
(a) the surrounding wall forms a rectangular shape including the opposing first wall section and second wall section, and a third wall section and opposing fourth wall section between the first and second wall sections;
(b) the first graphic symbol is located off-center on the first wall section; and
(c) the second graphic symbol is located off-center on the second wall section.

6. A container and lid arrangement according to claim 5 wherein:
(a) the first graphic symbol is located closer to the third wall section than the fourth wall section; and
(b) the second graphic symbol is located closer to the fourth wall section than the third wall section.

7. A container and lid arrangement according to claim 6 wherein:
(a) the container has a central vertical axis; and
(b) the first and second graphic symbols overlap with each other as the container is rotated 180° about the central vertical axis.

8. A container and lid arrangement according to claim 6 wherein:
(a) the lid has a center with imaginary first and second intersecting perpendicular lines dividing the lid into four quadrants; and
(b) the third graphic symbol is on the lid off-center and in only one of the four quadrants; wherein when the lid is operably on the rim of the container, the third graphic symbol is at one of two positions:
(i) closer to the first wall section and third wall section than the second wall section and fourth wall section; and
(ii) closer to the second wall section and fourth wall section than the first wall section and third wall section.

9. A container and lid arrangement according to claim 1 wherein:
(a) the container has a central vertical axis; and
(b) the first and second graphic symbols overlap with each other as the container is rotated 180° about the central vertical axis.

10. A container and lid arrangement according to claim 9 wherein:
(a) the surrounding wall forms one of a circular shape and a rectangular shape.

11. A container and lid arrangement according to claim 9 wherein:
(a) the first, second, and third graphic symbols are non-numeric and non-alphabetic.

12. A container and lid arrangement according to claim 1 wherein:
(a) the first, second, and third graphic symbols each have a size with a height greater than 0.5 inch and width greater than 0.5 inch.

13. A container and lid arrangement according to claim 1 wherein:
(a) the first, second, and third graphic symbols each have a size with a height no greater than 5 inches and width no greater than 3 inches.

14. A container and lid arrangement according to claim 1 wherein:
(a) the first, second, and third graphic symbols each have a size within 25% of each other.

15. A container and lid arrangement according to claim 1 wherein:
(a) the lid has a center; and
(b) the third graphic symbol is off-center on the lid.

16. A method of putting a lid on a disposable container; the method comprising:
(a) providing a container having a bottom and a surrounding wall extending from the bottom;
(i) the bottom and wall defining a container volume;
(ii) the wall having an end remote from the bottom; the end defining a lid-receiving rim;
(iii) the wall having at least a first wall section and a second opposing wall section;
(A) a first graphic arbitrary symbol defined on the first wall section; the first graphic arbitrary symbol having a purpose exclusively for use in a matching system and being otherwise uninformative;
(B) a second graphic arbitrary symbol defined on the second wall section; the second graphic symbol being the same as the first graphic symbol; the second graphic arbitrary symbol having a purpose exclusively for use in a matching system and being otherwise uninformative;
(b) viewing the container to see at least one of the first and second graphic symbols;
(c) locating a lid sized to fit the rim of the container by looking for a lid having a third graphic arbitrary symbol on the lid; the third graphic symbol being the same as the first and second graphic symbols; the third graphic arbitrary symbol having a purpose exclusively for use in a matching system and being otherwise uninformative; and
(d) operably placing the lid on the rim of the container to cover the container volume.

17. A method according to claim 16 wherein:
(a) the step of viewing the container to see at least one of the first and second graphic symbols includes seeing a non-numeric and non-alphabetic graphic symbol.

18. A method according to claim 16 wherein:
(a) the step of providing a container includes providing a container having a central vertical axis; and wherein the first and second graphic symbols overlap with each other as the container is rotated 180° about the central vertical axis.

19. A disposable container and lid arrangement comprising:
(a) a container having a bottom and a surrounding wall extending from the bottom;
(i) the bottom and wall defining a container volume;
(ii) the wall having an end remote from the bottom; the end defining a lid-receiving rim;
(iii) the wall having at least a first wall section and a second opposing wall section;
(A) a first graphic arbitrary symbol defined on the first wall section; the first graphic arbitrary symbol having a purpose exclusively for use in a matching system and being otherwise uninformative;
(B) a second graphic arbitrary symbol defined on the second wall section; the second graphic symbol being the same as the first graphic symbol; the second graphic arbitrary symbol having a purpose exclusively for use in a matching system and being otherwise uninformative;
(1) a straight line through the container volume between the first graphic symbol and second graphic symbol is non-perpendicular to the first wall section and the second wall section; and
(b) a lid sized to releasably fit on the rim and provide a cover to the container volume; the lid having a body extending over the container volume when the lid is operably fit on the rim;
(i) a third graphic arbitrary symbol defined on the body of the lid; the third graphic symbol being the same as the first and second graphic symbols; the third graphic arbitrary symbol having a purpose exclusively for use in a matching system and being otherwise uninformative;
(ii) the body of the lid has a center, and the third graphic symbol is off-center on the body of the lid.

20. A container and lid arrangement according to claim 1 wherein:
(a) the lid has a body extending over the container volume when the lid is operably fit on the rim; and
(b) the third graphic arbitrary symbol is defined on the body of the lid.
